(19) United States
(12) Patent Application Publication
(10) Pub. No.: US 2024/0127508 A1
(43) Pub. Date: Apr. 18, 2024

(54) GRAPHIC DISPLAY CONTROL APPARATUS, GRAPHIC DISPLAY CONTROL METHOD AND PROGRAM

(71) Applicant: NIPPON TELEGRAPH AND TELEPHONE CORPORATION, Tokyo (JP)

(72) Inventors: Yoko ISHII, Tokyo (JP); Momoko NAKATANI, Tokyo (JP); Ai NAKANE, Tokyo (JP); Chihiro TAKAYAMA, Tokyo (JP)

(73) Assignee: NIPPON TELEGRAPH AND TELEPHONE CORPORATION, Tokyo (JP)

(21) Appl. No.: 18/275,391

(22) PCT Filed: Feb. 3, 2021
(86) PCT No.: PCT/JP2021/003984

§ 371 Date: Aug. 1, 2023

(51) Int. Cl. G06T 11/60; G06F 3/01

(52) U.S. Cl. CPC G06T 11/60; G06F 3/011; G06F 3/017

(57) ABSTRACT

A graphic display control device comprising: a data acquisition unit that acquires an utterance content of a speaker as text data; a search information extraction unit that extracts search information to be used for searching, from the text data acquired by the data acquisition unit; a graphic selection unit that selects, from a database, a graphic corresponding to the search information extracted by the search information extraction unit; and an output function unit that performs processing for presenting the graphic selected by the graphic selection unit, on a graphic recording result.

### TECHNICAL FIELD

The present invention relates to a technique for controlling the display of graphics on a screen or a display.

### BACKGROUND ART

Currently, graphic recording techniques for graphically describing the content of a lecture or a dialogue between a plurality of people are being introduced in many fields.

The graphic described in the graphic recording is composed of not only characters but also pictures, drawings, and lines connecting them, and is characterized in being excellent in visualizing the relationship difficult to be transmitted only by characters.

### CITATION LIST

### Patent Literature

[PTL 1] Japanese Patent Application Laid-open No. 2017-068742

[PTL 2] Japanese Patent Application Laid-open No. 2017-004270

### SUMMARY OF INVENTION

### Technical Problem

However, in the graphic recording, there is no support for the act of searching for a passage that the speaker him/herself is interested in or a passage related to the speaker him/herself, making reading difficult.

On the other hand, in the case of a minute book described in writing, there is a method of searching for highly similar sentences, as disclosed in PTL 1. However, the technique disclosed in PTL 1 is intended for character information and cannot be applied to graphics.

The present invention has been made in view of the points described above, and it is an object of the present invention to provide a technique that enables a speaker to easily browse graphics that are interested in the speaker him/herself or graphics related to the speaker him/herself.

### Solution to Problem

According to the disclosed technique, provided is a graphic display control device, comprising:
a data acquisition unit that acquires an utterance content of a speaker as text data;
a search information extraction unit that extracts search information to be used for searching, from the text data acquired by the data acquisition unit;
a graphic selection unit that selects, from a database, a graphic corresponding to the search information extracted by the search information extraction unit; and
an output function unit that performs processing for presenting the graphic selected by the graphic selection unit, on a graphic recording result.

### Advantageous Effects of Invention

According to the disclosed technique, a technique is provided that enables a speaker to easily browse graphics that are interested in the speaker him/herself or graphics related to the speaker him/herself.

### BRIEF DESCRIPTION OF DRAWINGS

FIG. 1 is a system configuration diagram according to Example 1.

FIG. 2 is a configuration diagram of a graphic display control device according to Example 1.

FIG. 3 is a flow chart showing a flow of processing according to Example 1.

FIG. 4 is a system configuration diagram according to Example 2.

FIG. 5 is a configuration diagram of a graphic display control device according to Example 2.

FIG. 6 is a flow chart showing a flow of processing according to Example 2.

FIG. 7 is a diagram showing an example of arranging graphics in an image.

FIG. 8 is a diagram showing an example of arranging graphics in an image.

FIG. 9 is a diagram showing an example of arranging graphics in an image.

FIG. 10 is a diagram showing an example of a hardware configuration of a device.

### DESCRIPTION OF EMBODIMENTS

An embodiment (the present embodiment) of the present invention will now be described hereinafter with reference to the drawings. The embodiment described below is merely an example, and embodiments to which the present invention is applied are not limited to the following embodiment.

### Outline of Embodiment

First, the outline of the present embodiment will be described. In the present embodiment, a graphic display control device acquires information on an utterance or a motion of a person who utilizes a graphic of graphic recording, and extracts Information that the person is presumed to be currently interested in.

Further, the graphic display control device grasps a state of the person when acquiring the information on an utterance or a motion. The graphic display control device then selects a graphic to be shown to the person, from the information, and presents the selected graphic.

Since the graphic display control device performs the processing described above, the speaker can easily browse through the graphics depicted in the graphic recording which can be predicted to be of interest to him/her.

The graphic display control device can also adjust the manner of outputting graphics according to the dialogue state. Consequently, the speaker will be able to browse easily according to the situation of the person.

A system configuration and an operation example according to the present embodiment will be described hereinafter in detail by using Example 1 and Example 2.

### Example 1

<System Configuration>

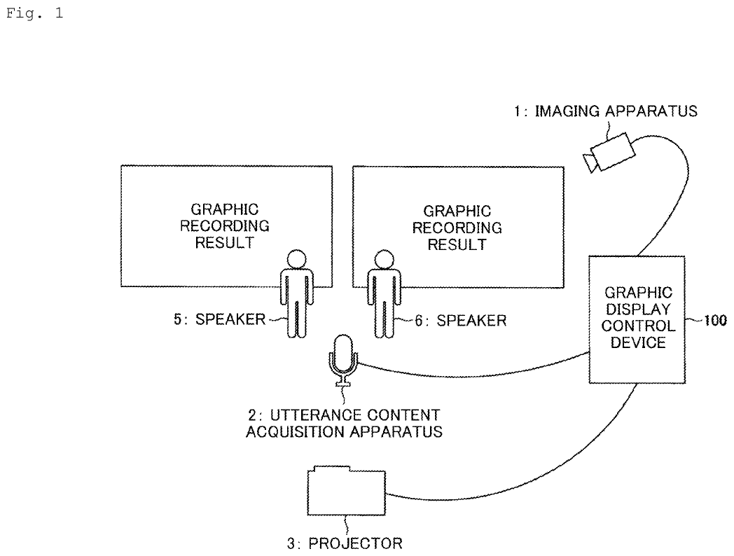

Example 1 will be described first. FIG. 1 is a configuration diagram of a graphic display control system according to Example 1. Example 1 assumes that one or more graphic recording results are displayed on a white board, a screen or the like, and that speakers 5 and 6 are speaking in front of the white board, screen, or the like. Note that the explanation will focus on the speaker 5, unless otherwise specified.

As shown in FIG. 1, the graphic display control system of Example 1 includes an imaging apparatus 1, an utterance content acquisition apparatus 2, a projector 3, and a graphic display control device 100. As shown in FIG. 1, the imaging apparatus 1, the utterance content acquisition apparatus 2, and the projector 3 are connected to the graphic display control device 100.

The imaging apparatus 1 is a device for photographing the speaker 5. The imaging apparatus 1 may be any device as long as it can capture the shape of a person. For example, a color video camera, an infrared camera, a three-dimensional measurement LiDAR, or the like can be used as the imaging apparatus 1.

The utterance content acquisition apparatus 2 is a device for acquiring an utterance content of the speaker 5. The utterance content acquisition apparatus 2 is, for example, a device for inputting an utterance voice of the speaker 5 from a microphone, transcribing the utterance voice, and outputting text data.

In a case where the speaker 5 leaves the utterance content in writing, the utterance content acquisition apparatus 2 may be a device that reads the content by an OCR or the like and outputs text data. In a case where the speaker 5 enters the utterance content through a keyboard, the utterance content acquisition apparatus 2 may be the keyboard.

Further, a part of the functions of the utterance content acquisition apparatus 2 may be implemented in the graphic display control device 100.

The projector 3 is a device for superimposing light on a graphic recording result. The projector 3 may be a projector or a movable light.

The projector 3 may also project a graphic recording result as a video on a screen or the like. When displaying a graphic recording result on a display, the projector 3 may not be provided. In this case, the superposition of the light performed by the projector 3 can be reproduced on the display.

The graphic display control device 100 is a device implemented by a computer (PC or the like) and a program, for example. The computer may be a virtual machine on a cloud. The graphic display control device 100 may be implemented by one computer or a plurality of computers.

<Configuration of Graphic Display Control 100>

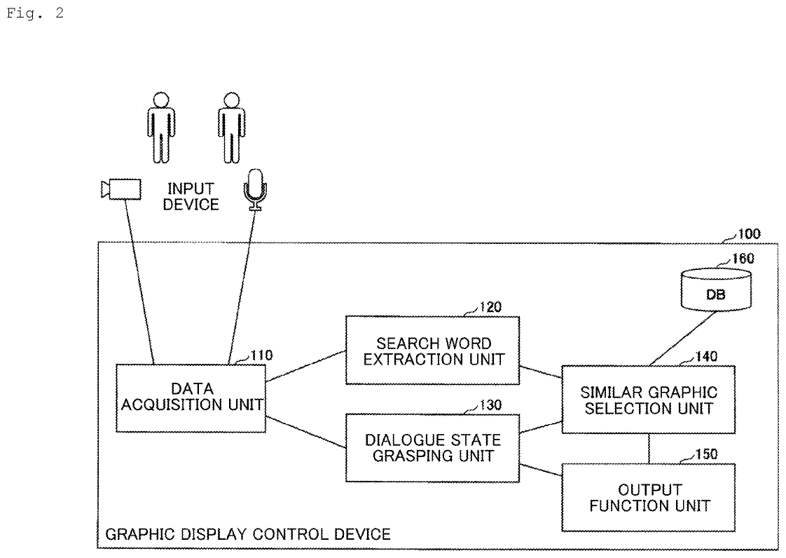

FIG. 2 shows a functional configuration example of the graphic display control device 100. As shown in FIG. 2, the graphic display control device 100 includes a data acquisition unit 110, a search word extraction unit 120, a dialogue state grasping unit 130, a similar graphic selection unit 140, an output function unit 150, and a DB (database) 160. Each functional unit may be implemented on another computer or some functional units may be implemented on a cloud. The search word extraction unit 120, the dialogue state grasping unit 130, and the similar graphic selection unit 140 may be referred to as a search information extraction unit, a filter strength setting unit, and a graphic selection unit, respectively.

<Information Held in DB 160>

In the DB 160, image information obtained by clustering graphics (image information) for each small group in advance and text data related to the information are stored. The small groups can be set arbitrarily, and the same graphic may be stored as a plurality of pieces of image information as different groups.

It should be noted that the above is an example, and any type of graphic (image information) and text data may be used if they are a set.

In Example 1, it is assumed that a graphic based on a graphic recording result is stored in the DB 160. For each of graphics held in the DB 160, the DB 160 includes positional information indicating at which position of the entire drawn graphic recording result the corresponding graphic is located. The positional information of a certain graphic may be stored, for example, as the coordinates of a point in the graphic, with a certain point in the entire graphic recording result as the origin. Further, the entire graphic recording result may be taken as a rectangular image, and pixel information including graphics may be held.

<Example of Operation of Graphic Display Control System>

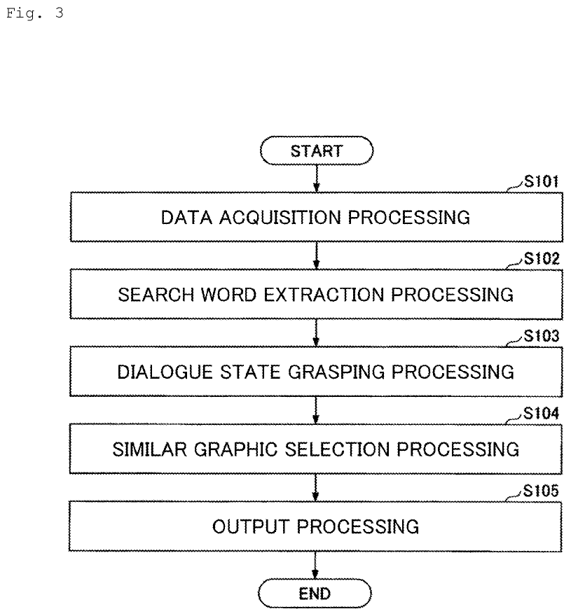

An example of an operation of the graphic display control system according to Example 1 will be described hereinafter in accordance with a procedure shown in the flowchart of FIG. 3.

It is considered that the speaker 5 interacts with the speaker 6 while viewing the graphic recording result. In this situation, the graphic display control system performs each processing described below.

<S101: Data Acquisition Processing>

The imaging apparatus 1 acquires a video of the speaker 5, recognizes the appearance when the speaker 5 enters the angle of view, and recognizes the disappearance when the speaker 5 disappears from the angle of view. The appearance and disappearance of the speaker 5 can be recognized by using, for example, openpose which is an open source. In addition to the appearance and disappearance, or in place of the appearance and disappearance, the imaging apparatus 1 may recognize a gesture such as a finger-pointing motion of the speaker 5. Motions recognized by the imaging apparatus 1 are not limited to the ones described above, and other motions may be recognized.

The imaging apparatus 1 transmits information obtained by adding a time code (time information) indicating the occurrence time at which the acquired motion has occurred and IDs for distinguishing speakers when a plurality of speakers exist to the motion of the speaker, to the data acquisition unit 110 of the graphic display control device 100.

The utterance content acquisition apparatus 2 acquires the utterance content of the speaker 5, imparts time information indicating the time when the original utterance is performed, and transmits text data representing the utterance content to the data acquisition unit 110 of the graphic display control device 100.

The data acquisition unit 110 receives the text data to which the time information is attached, from the utterance content acquisition apparatus 2, and transmits the received text data to the search word extraction unit 120. The data acquisition unit 110 also receives the information on the motion of the speaker 5 to which the time information is attached, from the imaging apparatus 1, and transmits the information on the motion to the dialogue state grasping unit 130.

<S102: Search Word Extraction Processing>

The search word extraction unit 120 extracts information to be used for searching for a graphic from the text data received from the data acquisition unit 110. The method of extracting information from text data is not limited to a specific method, and various methods can be used.

For example, the search word extraction unit 120 may summarize the text data received from the data acquisition unit 110 by using an existing technique, divide the summarized document into sentences, and use the divided sentences as information for searching.

The search word extraction unit 120 transmits each sentence obtained in the above-described manner to the similar graphic selection unit 140 together with time information included in the original text data.

In addition to the method described above, the search word extraction unit 120 may perform morphological analysis on the text data received from the data acquisition unit 110, and utilize a word appearing n times or more within a certain period (t1 seconds, in this case) as information for searching. It is assumed that arbitrary values are set as t1 and n. It is also assumed that one or more arbitrary parts of speech can also be set for the part of speech of the word to be counted for n.

When one or more words are extracted from the text data as information for searching for a graphic, information obtained by numbering the frequency in order from the one having a large number of appearances is imparted to the one or more words, and the resultant information is transmitted to the similar graphic selection unit 140 together with the time information included in the original text data.

<S103: Dialogue State Grasping Processing>

The dialogue state grasping unit 130 receives the information on the motion to which the time information is attached, from the data acquisition unit 110, and sets a value of a filter strength variable corresponding to the motion. The value of the filter strength variable is a value representing the filter strength, and the value of the filter strength variable may be referred to as the filter strength. The filter strength indicates the degree at which a specific graphic is selected (that is, the degree of filtering other graphics) in similar graphic selection processing to be described later.

The value of the filter strength variable may be set for each motion or may be set for each time-series change occurring after the motion is performed. Which filter strength to set for which action/time-series change may be determined in advance in a table or the like, for example, and may be determined by referring to that table.

When setting for each motion, for example, two motions of “pointing motion” and “appearance” are set such that F1 is set for “pointing motion” and F2 for “appearance.” F1 means that the filter strength is higher (stronger) than F2.

The example described above implies that the degree of attention is considered high when the pointing motion is performed, so that the filter strength is set so as to select a graphic having a high degree of similarity, and that the degree of attention is low when only appearance is obtained, so that the filter strength is set so as to select a graphic having a low degree of similarity. Specifically, for example, F1 and F2 are set such that a threshold α (F1) to be described later becomes 0.9 and a threshold α (F2) becomes 0.7.

When setting for each time-series change, for example, a time after appearance is measured for each speaker, and when the time is less than T1, the filter strength may be set to F1, and when the time is T1 or more, the filter strength may be set to F2.

Further, the dialogue state grasping unit 130 may set a value of an arbitrary filter strength by a combination of a motion and time information of the motion.

The dialogue state grasping unit 130 may receive the time from the appearance of the speaker 5 and/or the value of a filter strength variable corresponding to the motion, and set a value that is output by solving a predetermined function based on these pieces of information, as the value of the filter strength variable.

Further, when a plurality of speakers are present, the value of another filter strength variable may be newly set for each speaker from a combination of values of filter strength variables set for each speaker on the basis of a motion and a time-series change. Also, when a plurality of speakers are present, the time from the appearance of each speaker and/or the value of the filter strength variable corresponding to the operation may be received, and the value that is output by solving a predetermined function on the basis of the information may be set as the value of the filter strength variable for each speaker.

The dialogue state grasping unit 130 transmits the value of the filter strength variable corresponding to the motion of the speaker 5 to each of the similar graphic selection unit 140 and the output function unit 150.

<S104: Similar Graphic Selection Processing>

The similar graphic selection unit 140 receives information for searching for a graphic from the search word extraction unit 120, and stores the received information as graphic search information together with time information attached to original text data. The time information here may be the time at which the graphic search information is received.

Furthermore, the similar graphic selection unit 140 receives the value of the filter strength variable from the dialogue state grasping unit 130 and stores it together with the time information of the original motion. The time information here may be the time at which the value of the filter strength variable is received.

Upon reception of either the graphic search information or the value of the filter strength variable, the similar graphic selection unit 140 executes the following processing.

The similar graphic selection unit 140 confirms the time information of the latest graphic search information held currently and the time information of the value of the latest filter strength variable held currently, and performs the next processing by using the latest graphic search information and the value of the latest filter strength variable when the deviation of the time is T or less. Here, T is a value of a predetermined time.

The similar graphic selection unit 140 selects a graphic corresponding to the graphic search information from the DB 160 by using the graphic search information.

As described above, the graphic search information is composed of text data such as sentences and words, and graphics stored in the DB 160 are also stored together with text data related to the graphics.

The similar graphic selection unit 140 selects a graphic having text data similar to the graphic search information. Although the method for selecting graphics having text data similar to the graphic search information is not limited to a specific method, the method described in PTL 1, for example, may be used.

That is, the similar graphic selection unit 140 obtains a similarity score between text data which is graphic search information and each piece of text data associated with graphics stored in a DB 160, and selects one or more graphics corresponding to one or more pieces of text data whose similarity score is higher than a threshold.

Further, the threshold value α (n) may be set for each value n of the filter strength variable with respect to the threshold to be compared with the similarity score obtained by the method described in PTL 1. In this case, the similar graphic selection unit 140 selects one or more graphics corresponding to text data whose similarity score with the graphic search information is larger than the threshold α (F), by using the threshold α (F) corresponding to the value F of the filter strength variable obtained from a motion corresponding to the graphic search information to be used.

The similar graphic selection unit 140 transmits the one or more selected graphics to the output function unit 150. When a plurality of graphics are obtained, all the graphics are transmitted to the output function unit 150. When transmitting the graphics, the similar graphic selection unit 140 may also transmit the information used for the search (e.g., text data transmitted from the data acquisition unit 110, or graphic search information).

<S105: Output Processing>

The output function unit 150 receives the value of the filter strength variable from the dialogue state grasping unit 130. Further, the output function unit 150 receives information on one or more graphics from the similar graphic selection unit 140. Here, it is assumed that the output function unit 150 receives the value of the filter strength variable corresponding to the motion of the speaker 5, as well as information on one or more graphics obtained from the text search information related to said motion (e.g., within a time difference of T).

The output function unit 150 performs processing for making the graphics conspicuous on the graphic recording result on the basis of the received information of the graphics, and outputs the graphics to the projector 3 and the like.

More specifically, for example, the output function unit 150 may project light toward a portion of the positional information in the graphic recording result presented on a white board or the like, on the basis of the positional information of the graphics to be conspicuous. Further, the output function unit 150 may use the image information of the graphics to be conspicuous and project the video from the projector 3 onto the graphic recording result so that the outline can be highlighted.

When the graphic recording result is an image projected from the projector 3 and displayed on a screen or when the graphic recording result is an image displayed on a display, the output function unit 150 may change a graphic to be conspicuous to text data of information used for searching, display the text data on the screen or display as words spoken by the speaker 5, and then superimpose the graphic to be conspicuous on the text data to display it so as to be conspicuous.

The method of displaying graphics and text data as described above (display method) is an example, and is not limited to the one described above. Also, the way of showing graphics and text data may be made different for each speaker, or the way of showing graphics and text data may be changed according to the lapse of time.

### Effects of Example 1

According to Example 1, it is possible for the speaker to easily find the portions of the graphic depicted in the graphic recording that are of interest or relevant to him/her.

### Example 2

Example 2 will be described next. Example 2 may be carried out alone or in combination with Example 1.

Example 2 may also assume that the portions of interest in the speaker are selected from graphics depicted by graphic recording and arranged in chronological order so as to be easily browsed, or assume that graphics related to the speaker are arranged in chronological order so as to be easily browsed.

<System Configuration>

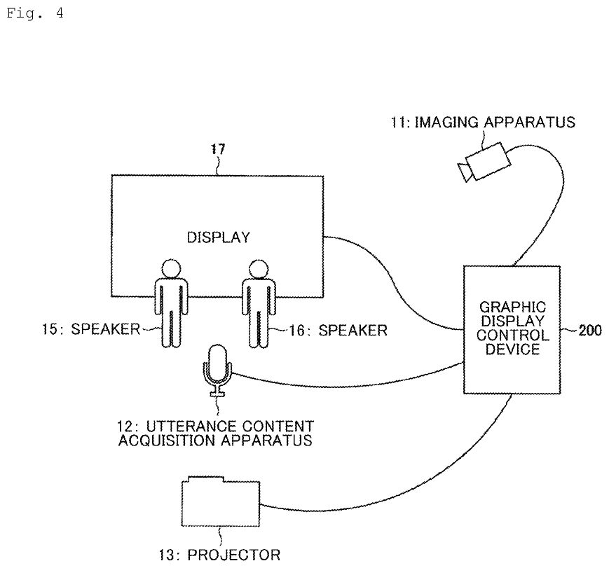

FIG. 4 is a configuration diagram of a graphic display control system according to Example 2. In Example 2, a graphic recording result may or may not be displayed on a display 17. Here, it is assumed that speakers 15 and 16 are speaking in front of the display 17. Note that the explanation will focus on the speaker 15, unless otherwise specified.

As shown in FIG. 4, the graphic display control system according to Example 2 includes an imaging apparatus 11, an utterance content acquisition apparatus 12, a projector 13, the display 17, and a graphic display control device 200. As shown in FIG. 4, the imaging apparatus 11, the utterance content acquisition apparatus 12, the projector 13, and the display 17 are connected to the graphic display control device 200. Only either one of the projector 13 and the display 17 may be provided, or both of them may be provided.

The imaging apparatus 11 is a device for photographing the speaker 15. The imaging apparatus 11 may be any device as long as it can capture the shape of a person. For example, a color video camera, an infrared camera, a three-dimensional measurement LiDAR, or the like can be used as the imaging apparatus 11.

The utterance content acquisition apparatus 12 is a device for acquiring an utterance content of the speaker 15. The utterance content acquisition apparatus 12 is, for example, a device for inputting an utterance voice of the speaker 15 from a microphone, transcribing the utterance voice, and outputting text data.

In a case where the speaker 15 leaves the utterance content in writing, the utterance content acquisition apparatus 12 may be a device that reads the content by an OCR or the like and outputs text data. In a case where the speaker 15 enters the utterance content through a keyboard, the utterance content acquisition apparatus 12 may be the keyboard.

In addition, a part of the function of the utterance content acquisition apparatus 12 may be mounted in the graphic display control device 200.

Both of the projector 13 and the display 16 display the video obtained after the reconstruction of the graphic recording. The projector 13 may be a projector or a movable light.

The graphic display control device 200 is a device implemented by a computer (PC or the like) and a program, for example. The computer may be a virtual machine on a cloud. The graphic display control device 200 may be implemented by one computer or a plurality of computers.

<Configuration of Graphic Display Control 200>

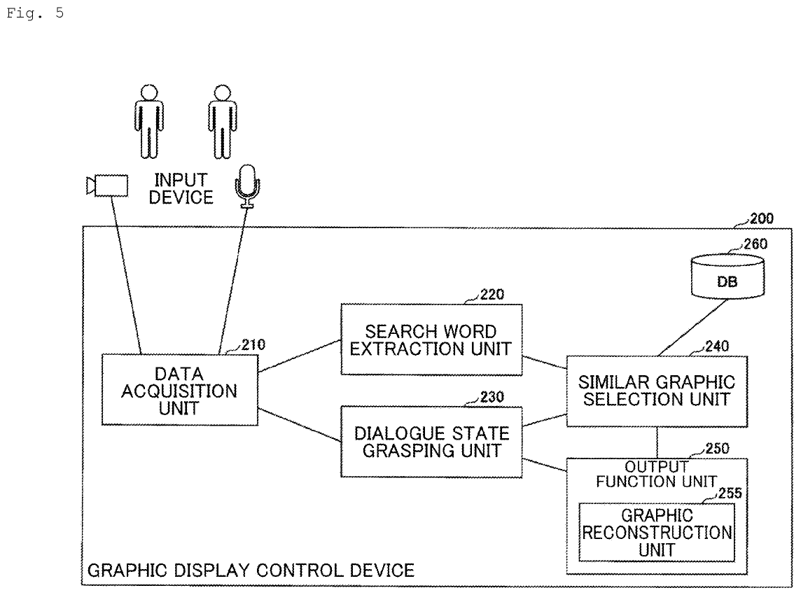

FIG. 5 shows a functional configuration example of the graphic display control device 200. As shown in FIG. 5, the graphic display control device 200 includes a data acquisition unit 210, a search word extraction unit 220, a dialogue state grasping unit 230, a similar graphic selection unit 240, an output function unit 250, and a DB (database) 260. The output function unit 250 includes a graphic reconstruction unit 255. Each functional unit may be implemented on another computer or some functional units may be implemented on a cloud. The search word extraction unit 220, the dialogue state grasping unit 230, and the similar graphic selection unit 240 may be referred to as a search information extraction unit, a filter strength setting unit, and a graphic selection unit, respectively.

<Information Held in DB 260>

In the DB 260, image information obtained by clustering graphics (image information) for each small group in advance and text data related to the information are stored. The small groups can be set arbitrarily, and the same graphic may be stored as a plurality of pieces of image information as different groups.

It should be noted that the above is an example, and any type of graphic (image information) and text data may be used if they are a set.

In Example 2, information about the graphic recording result may not be stored in the DB 260. In the case of storing information about the graphic recording result, for example, as in Example 1, the DB 260 stores, for each graphic stored in the DB 260, the graphic includes positional information indicating at which position of the entire depicted graphic recording result the graphic is located. The positional information of a certain graphic may be stored, for example, as the coordinates of a point in the graphic, with a certain point in the entire graphic recording result as the origin. Further, the entire graphic recording result may be taken as a rectangular image, and pixel information including graphics may be held.

<Example of Operation of Graphic Display Control System>

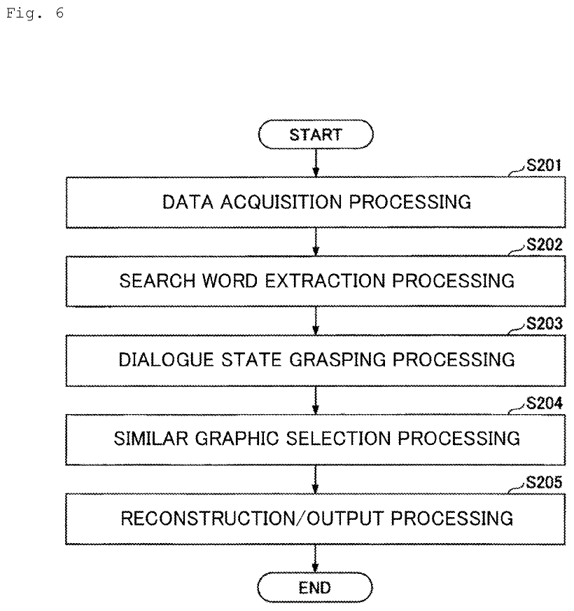

In Example 2, it is assumed that the speaker 15 is interacting with the speaker 16. The graphic display control system of Example 2 executes the operation in accordance with the procedure of the flowchart shown in FIG. 6.

The imaging apparatus 11, the utterance content acquisition apparatus 12, the data acquisition unit 210, the search word extraction unit 220, the dialogue state grasping unit 230, the similar graphic selection unit 240, and the DB 260 according to Example 2 perform the same operations as those of the imaging apparatus 1, the utterance content acquisition apparatus 2, the data acquisition unit 110, the search word extraction unit 120, the dialogue state grasping unit 130, the similar graphic selection unit 140, and the DB 160.

That is, the operations from S201 to S204 shown in FIG. 6 are the same as the operations from S101 to S104 shown in FIG. 3 according to Example 1. The operation of S205 according to Example 2 will be described below.

<S205: Reconstruction/Output Processing>

The output function unit 250 receives a value of a filter strength variable from the dialogue state grasping unit 230. Further, the output function unit 250 receives information on one or more graphics from the similar graphic selection unit 240. Here, it is assumed that the output function unit 250 receives the value of the filter strength variable corresponding to the motion of the speaker 15, as well as information on one or more graphics obtained from the text search information related to said motion (e.g., within a time difference of T). The same is true for a plurality of speakers, and the output function unit 250 receives, for each speaker, the value of the filter strength variable corresponding to the motion and receives one or more graphics obtained from the text search information related to the motion (e.g., within a time difference of T).

The output function unit 250 passes the received value of the filter strength variable and graphic information to the graphic reconstruction unit 255. The graphic reconstruction unit 255 reconstructs a graphic based on the value of the filter strength variable and the information of the graphic, and outputs the reconstructed graphic through the output function unit 250.

More specifically, the graphic reconstruction unit 255 arranges, in chronological order, graphics sent to the output function unit 255 on a rectangular image which can be projected on a screen by the projector 13, or arrange the graphics on a rectangular image which can be displayed on the display 16. Here, the in chronological order may be determined, for example, from time information of graphic search information which is a source from which a graphic is selected, or may be determined from the time at which the graphic information is received.

As to the arrangement on the rectangular image, a preset arrangement is performed. The setting method is arbitrary.

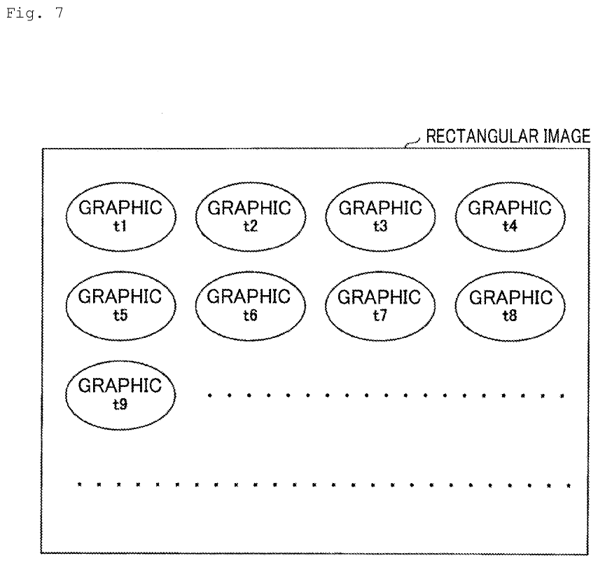

As an example, the graphic reconstruction unit 255 arranges the graphics from left to right and from top to bottom of the image in chronological order of the time at which the output function unit 250 receives the graphic information. FIG. 7 shows an example of the arrangement in which the graphics are arranged from left to right and from top to bottom of the image. In FIG. 7, t1, t2 and the like represent advancing times. Reference signs t1, t2, and the like are not described on the image, but are described in FIG. 7.

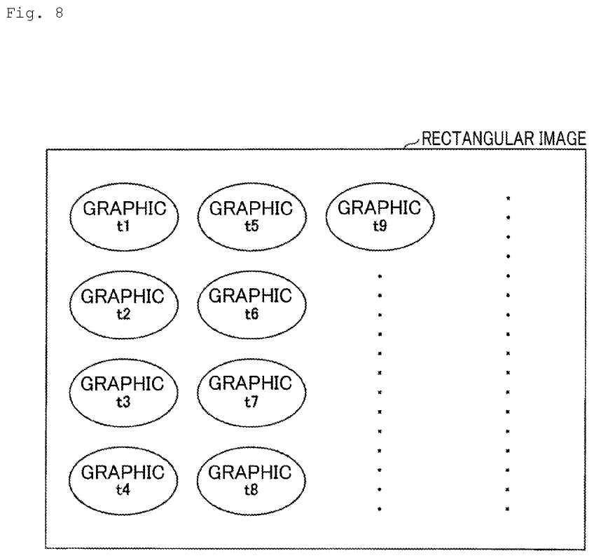

The graphic reconstruction unit 255 may arrange images downward from the left end in chronological order of the time at which the output function unit 250 receives the graphic information, and may arrange images downward again from the left end of the remaining space upon reaching the image bottom. FIG. 8 shows an example of this case.

The image on which the graphics are arranged is projected from the output function unit 250 through the projector 13 or displayed on the display 17. The image may be newly generated every time the output function unit 250 receives the graphic information.

Also, regarding the arrangement of graphics on the image, the graphic reconstruction unit 255 may group graphics by the value of the filter strength variable corresponding to the graphics, and may arrange one or more grouped graphics.

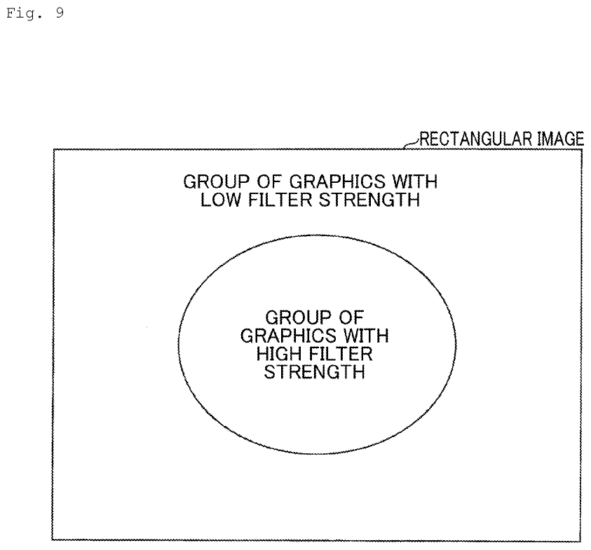

The method of grouping is not limited to a specific method: for example, a group of one or more graphics corresponding to values of the same filter strength variable may be arranged in chronological order of the time at which the graphic information is received. As an example, as shown in FIG. 9, graphics having high filter strength may be arranged in the central portion of the image in chronological order, and graphics having low filter strength may be arranged around the graphics having high filter strength.

The graphic reconstruction unit 255 may color-classify graphics for each graphic having the same filter strength variable value. The color in this case may be set in advance for each value of the filter strength variable or may be selected randomly.

Further, when a predetermined time T2 elapses after a graphic having a value of a certain filter strength variable is projected or displayed by the output function unit 250, the graphic may be erased from the image. For the time T2, the same value may be used for all filter strength variables, or the time T2 may be set as a different value for each filter strength variable. As an example, in the case of setting T2 in such a manner that the higher the filter strength is, the longer the display time is, for a plurality of graphics displayed as shown in FIG. 7, the graphics are erased starting from the one with a low filter strength, in accordance with the lapse of time.

### Effects of Example 2

According to Example 2, graphics can be displayed so as to be easily browsed, according to the situation of the speakers.

### Hardware Configuration Example

As described above, both graphic display control devices 100 and 200 described in Examples 1 and 2 can be realized, for example, by having one or more computers execute a program. This computer may be a physical computer or may be a virtual machine.

In other words, the graphic display control devices 100 and 200 can be realized by using hardware resources such as CPUs and memory built into computers, to execute programs corresponding to the processing performed by the graphic display control devices 100 and 200. The program can be recorded on a computer-readable recording medium (portable memory, and the like), stored, and distributed. It is also possible to provide the program through a network such as the Internet or an email.

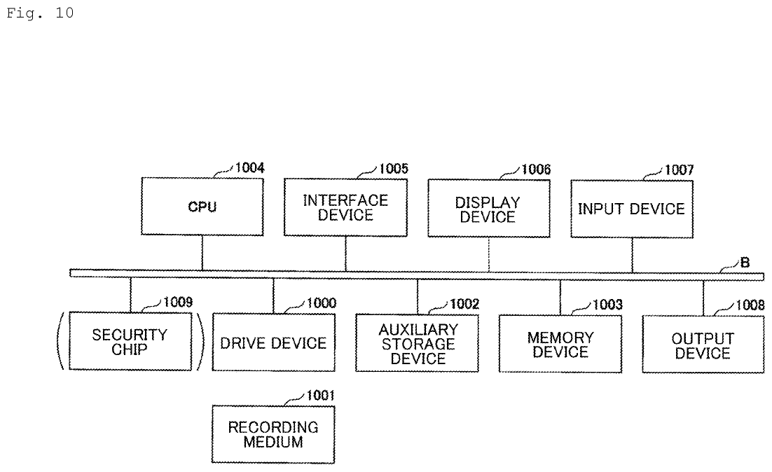

FIG. 10 is a diagram illustrating a hardware configuration example of the computer. The computer of FIG. 10 has a drive device 1000, an auxiliary storage device 1002, a memory device 1003, a CPU 1004, an interface device 1005, a display device 1006, an input device 1007, and the like, which are connected to each other by a bus B.

A program for realizing the processing of the computer is provided by a recording medium 1001 such as a CD-ROM or a memory card, for example. When the recording medium 1001 storing the program is set in the drive device 1000, the program is installed onto the auxiliary storage device 1002 from the recording medium 1001 via the drive device 1000. However, the program does not necessarily have to be installed from the recording medium 1001, and may be downloaded from another computer via the network. The auxiliary storage device 1002 stores necessary files, data, and so forth, as well as storing the installed program.

The memory device 1003 reads out and stores the program from the auxiliary storage device 1002, if there is a program activation instruction. The CPU 1004 realizes a function related to the graphic display control devices 100 and 200 according to the program stored in the memory device 1003. The interface device 1005 is used as an interface for connecting to the network, and functions as an input means and an output means via the network. The display device 1006 displays a GUI (Graphical User Interface) or the like based on a program. The input device 1007 is configured of a keyboard, a mouse, buttons, a touch panel, and the like, and is used for inputting various operation instructions. The output device 1008 outputs computation results.

### Summary of Embodiment

The present specification discloses at least the graphic display control device, the graphic display control method, and the program according to each of the following sections.

(Section 1)

A graphic display control device, comprising:
a data acquisition unit that acquires an utterance content of a speaker as text data;
a search information extraction unit that extracts search information to be used for searching, from the text data acquired by the data acquisition unit;
a graphic selection unit that selects, from a database, a graphic corresponding to the search information extracted by the search information extraction unit; and
an output function unit that performs processing for presenting the graphic selected by the graphic selection unit, on a graphic recording result.

(Section 2)

A graphic display control device, comprising:
a data acquisition unit that acquires an utterance content of a speaker as text data;
a search information extraction unit that extracts search information to be used for searching, from the text data acquired by the data acquisition unit;
a graphic selection unit that selects, from a database, a graphic corresponding to the search information extracted by the search information extraction unit; and
an output function unit that performs processing for displaying the graphic selected by the graphic selection unit, in chronological order.

(Section 3)

The graphic display control device according to section 1 or 2, further comprising a filter strength setting unit that sets a filter strength on the basis of information on a motion of the speaker acquired by the data acquisition unit,
wherein the graphic selection unit selects, from the database, a graphic similar to the search information by using a threshold corresponding to the filter strength set by the filter strength setting unit.

(Section 4)

The graphic display control device according to section 3 dependent from section 2, wherein the output function unit groups graphics on the basis of the filter strength.

(Section 5)

The graphic display control device according to section 3 dependent from section 2, wherein the output function unit determines a time between displaying a graphic and erasing the graphic on the basis of the filter strength.

(Section 6)

A graphic display control method executed by a graphic display control device, the graphic display control method comprising:
a data acquisition step of acquiring an utterance content of a speaker as text data;
a search information extraction step of extracting search information to be used for searching, from the text data acquired in the data acquisition step;
a graphic selection step of selecting, from a database, a graphic corresponding to the search information extracted in the search information extraction step; and
an output step of performing processing for presenting the graphic selected in the graphic selection step on a graphic recording result.

(Section 7)

A graphic display control method executed by a graphic display control device, the graphic display control method comprising:
a data acquisition step of acquiring an utterance content of a speaker as text data;
a search information extraction step of extracting search information to be used for searching, from the text data acquired in the data acquisition step;
a graphic selection step of selecting, from a database, a graphic corresponding to the search information extracted in the search information extraction step; and
an output step of performing processing for displaying the graphic selected in the graphic selection step, in chronological order.

(Section 8)

A program for causing a computer to function as each of the units of the graphic display control device according to any one of sections 1 to 5.

While an embodiment of the present invention has been described above, the present invention is not limited to such specific embodiment, and various modifications and changes are possible within the scope of the gist of the present invention described in the claims.

### REFERENCE SIGNS LIST

1 Imaging apparatus
2 Utterance content acquisition apparatus
3 Projector
5, 6 Speaker
100 Graphic display control device
110 Data acquisition unit
120 Search word extraction unit
130 Utterance state grasping unit
140 Similar graphic selection unit
150 Output function unit
160 DB
11 Imaging apparatus
12 Utterance content acquisition apparatus
13 Projector
15, 16 Speaker
17 Display
200 Graphic display control device
210 Data acquisition unit
220 Search word extraction unit
230 Utterance state grasping unit
240 Similar graphic selection unit
250 Output function unit
255 Graphic reconstruction unit
260 DB
1000 Drive device
1001 Recording medium
1002 Auxiliary storage device
1003 Memory device
1004 CPU
1005 Interface device
1006 Display device
1007 Input device
1008 Output device

1. A graphic display control device, comprising a processor configured to execute operations comprising:
acquiring an utterance content of a speaker as text data;
extracting search information to be used for searching, from the text data;
selecting, from a database, a graphic corresponding to the search informations; and
performing processing for presenting the graphic on a graphic recording result.

2. A graphic display control device, comprising a processor configured to execute operations comprising:
acquiring an utterance content of a speaker as text data;
extracting search information to be used for searching, from the text data;
selecting, from a database, a graphic corresponding to the search information; and
performing processing for displaying the graphic, in chronological order.

3. The graphic display control device according to claim 2, further comprising the processor further configured to execute operations comprising:
setting a filter strength on the basis of information on a motion of the speaker,
wherein the selecting further comprises selecting, from the database, a graphic similar to the search information by using a threshold corresponding to the filter strength.

4. The graphic display control device according to claim 3, wherein the performing processing for displaying the graphic further comprises grouping graphics on the basis of the filter strength.

5. The graphic display control device according to claim 3, wherein performing processing for displaying the graphic further comprises determining a time between displaying a graphic and erasing the graphic on the basis of the filter strength.

6. A computer implemented method for controlling graphic display, the method comprising:
a data acquisition step of acquiring an utterance content of a speaker as text data;
a search information extraction step of extracting search information to be used for searching, from the text data acquired in the data acquisition step;
a graphic selection step of selecting, from a database, a graphic corresponding to the search information extracted in the search information extraction step; and
an output step of performing processing for presenting the graphic selected in the graphic selection step on a graphic recording result.

7-8. (canceled)

9. The graphic display control device according to claim 1 further comprising the processor further configured to execute operations comprising:
setting a filter strength on the basis of information on a motion of the speaker,
wherein the selecting further comprises selecting, from the database, a graphic similar to the search information by using a threshold corresponding to the filter strength.

10. The graphic display control device according to claim 1, wherein the selecting further comprises receiving data associated with the graphic, and
the performing processing for presenting the graphic further comprises emphasizing, based on the data associated with the graphic, the graphic.

11. The graphic display control device according to claim 10, wherein the emphasizing the graphic further comprises projecting light toward a portion of the graphic recording result.

12. The graphic display control device according to claim 10, wherein the emphasizing the graphic further comprises highlighting outline of the graphic.

13. The computer implemented method according to claim 6, further comprising:
setting a filter strength on the basis of information on a motion of the speaker, wherein the selecting further comprises selecting, from the database, a graphic similar to the search information by using a threshold corresponding to the filter strength.

14. The computer implemented method according to claim 6, wherein the selecting further comprises receiving data associated with the graphic, and
the performing processing for presenting the graphic further comprises emphasizing, based on the data associated with the graphic, the graphic.

15. The computer implemented method according to claim 14, wherein the emphasizing the graphic further comprises projecting light toward a portion of the graphic recording result.

16. The computer implemented method according to claim 14, wherein the emphasizing the graphic further comprises highlighting outline of the graphic.
